(19) United States
(12) Patent Application Publication
(10) Pub. No.: US 2013/0119270 A1
(43) Pub. Date: May 16, 2013

(54) WAVELENGTH DIVISION DEVICES, MULTI-WAVELENGTH LIGHT GENERATORS AND OPTICAL BIOSENSOR SYSTEMS USING THE SAME

(71) Applicant: Samsung Electronics Co., Ltd., Suwon-Si (KR)

(72) Inventors: Sung-Dong SUH, Seoul (KR); Kyoung-Won NA, Seoul (KR); Yoon-Dong PARK, Osan-si (KR); Beom-Suk LEE, Yongin-si (KR); Dong-Mo IM, Jeollanam-do (KR)

(73) Assignee: SAMSUNG ELECTRONICS CO., LTD., Suwon-Si (KR)

(21) Appl. No.: 13/670,087

(22) Filed: Nov. 6, 2012

Related U.S. Application Data
(60) Provisional application No. 61/560,440, filed on Nov. 16, 2011.

(30) Foreign Application Priority Data
Sep. 19, 2012 (KR) 10-2012-0103740

(51) Int. Cl. F21V 8/00; G02B 27/10; G01N 21/64

(52) U.S. Cl. CPC G02B 6/0001; G01N 21/6428; G02B 27/1006
USPC 250/458.1; 359/577; 362/551; 362/555

(57) ABSTRACT

A multi-wavelength light generator includes a broadband light source and a wavelength division device. The multi-wavelength light generator is configured to generate a first output light having a first line width. The wavelength division device is configured to divide a wavelength of the first output light to provide a plurality of second output lights. Each of the second output lights has a second line width narrower than the first line width, and each of the second output lights is used as a light source of each channel of an optical sensor.

### CROSS-REFERENCE TO RELATED APPLICATION(S)

This application claims priority under 35 USC §119 to U.S. provisional application No. 61/560,440, filed on Nov. 16, 2011, in the USPTO and Korean Patent Application No. 10-2012-0103740, filed on Sep. 19, 2012, in the Korean Intellectual Property Office (KIPO), the contents of which are incorporated herein in its entirety by reference.

### BACKGROUND

1. Technical Field

At least one example embodiment relates to biosensors, and more particularly to a wavelength division device, and a multi-wavelength light generator and/or an optical biosensor system including the same.

2. Discussion of the Related Art

Generally, biosensors are devices for detecting existence of proteins, such as antigens and antibodies, and bio materials, such as cells and concentration change of the proteins in the bio materials. Biosensors are used in various fields, such as fields relating to food, medical care, defense, and environment.

In a typical bio material detection method, a specific antibody is labeled with a fluorescent material, and variation of fluorescence is detected. Recently, label-free detection methods that do not use a label material have been developed.

When a plurality of bio materials are to be simultaneously detected, one light source and one driver for each channel are required, which increases power consumption and overall system size.

### SUMMARY

At least one example embodiment provides a wavelength division device and/or a multi-wavelength light generator including the wavelength division device that reduces power consumption and/or overall system size.

At least one example embodiment provides an optical biosensor system including the multi-wavelength light generator and the wavelength division device.

According to at least one example embodiment, a multi-wavelength light generator comprises a broadband light source configured to generate a first output light having a first line width; and a wavelength division device configured to divide a wavelength of the first output light to provide a plurality of second output lights, each of the second output lights having a second line width narrower than the first line width, and each of the second output lights being a light source of each channel in an optical sensor.

According to at least one example embodiment, the multi-wavelength light generator further comprises a driver configured to drive the broadband light source by direct modulation.

According to at least one example embodiment, the broadband light source includes an amplified spontaneous emission (ASE) light-emitting diode (LED).

According to at least one example embodiment, wherein the wavelength division device includes an arrayed waveguide grating (AWG).

According to at least one example embodiment, the AWG comprises an input waveguide configured to receive the first output light; a plurality of output waveguides configured to output the plurality of second output lights; a first slab waveguide connected to the input waveguide; a second slab waveguide connected to the plurality of output waveguides; and a waveguide array connected to the first slab waveguide and the second slab waveguide.

According to at least one example embodiment, the wavelength division device includes a ring-type demultiplexer.

According to at least one example embodiment, the ring-type demultiplexer comprises an input waveguide configured to receive the first output light; a plurality of ring resonators adjacent to the input waveguide; and a plurality of output waveguides adjacent to the plurality of ring resonators, each of the output waveguides being configured to provide each of the second output lights.

According to at least one example embodiment, a center wavelength of each of the second output lights is determined by each radius of the plurality of ring resonators.

According to at least one example embodiment, each ring resonator in the plurality of ring resonators has a different radius.

According to at least one example embodiment, the wavelength division device includes a multi-mode interference (MMI)-based demultiplexer.

According to at least one example embodiment, the MMI-based demultiplexer comprises an input waveguide configured to receive the first output light; a plurality of output waveguides configured to output the plurality of second output lights; a first MMI coupler connected to the input waveguide; a second MMI coupler connected to the plurality of output waveguides; and a waveguide array connected to the first MMI coupler and the second MMI coupler.

According to at least one example embodiment, a center wavelength of each of the second output lights is determined by a length of each waveguide in a plurality of waveguides in the waveguide array.

According to at least one example embodiment, an optical biosensor system comprises a multi-wavelength light generator configured to generate a plurality of second output lights based on a first output light having a first line width, each of the second output lights having a second line width narrower than the first line width; an optical biosensor configured to receive the plurality of second output lights; and a detection unit configured to receive a plurality of reacted lights and detect each peak wavelength of the reacted lights, the reacted lights being based on antibody-antigen reaction of the plurality of second output lights, the multi-wavelength light generator including a broadband light source configured to generate the first output light, and a wavelength division device configured to divide a wavelength of the first output light to provide the plurality of second output lights, each of the second output lights being a light source of each channel between the optical biosensor and the detection unit.

According to at least one example embodiment, the detection unit comprise a plurality of photodiodes configured to receive the plurality of reacted lights; and a peak wavelength detector configured to detect a peak wavelength in each photodiode of the plurality of photodiodes.

According to at least one example embodiment, the peak wavelength detector is configured to detect the peak wavelength by measuring a current generated by a reverse bias voltage applied to each photo-diode of the plurality of photodiodes.

According to at least one example embodiment, a wavelength division device, comprising: a first coupler configured to divide input light having a first line width into a plurality of first output lights having a second line width, the second line width being less than the first line width; a second coupler configured to output a plurality of second output lights based on the plurality of first output lights, each of the plurality of second output lights being a light source of each channel of an optical sensor; and a waveguide configured to transmit the plurality of first output lights to the second coupler.

According to at least one example embodiment, at least one of the first and second couplers comprises a substrate; and an interference pattern on the substrate, the interference pattern including a lower clad layer, an upper clad layer, and a core layer between the lower clad layer and the upper clad layer.

According to at least one example embodiment, wherein the lower clad layer includes a trench, and the core layer fills the trench.

According to at least one example embodiment, the upper clad layer includes a clad protrusion portion extending from a center region of the upper clad layer.

According to at least one example embodiment, a width of the interference pattern gradually decreases over a length of interference pattern.

Accordingly, the multi-wavelength light generator and the biosensor system may reduce power consumption and overall system size because each channel receives a light source generated by dividing a wavelength of one broadband light source.

### BRIEF DESCRIPTION OF THE DRAWINGS

Illustrative, non-limiting exemplary embodiments will be more clearly understood from the following detailed description taken in conjunction with the accompanying drawings.

FIG. 1 is a block diagram illustrating a multi-wavelength light generator according to at least one example embodiment.

FIG. 2 is a graph illustrating wavelength-power characteristic of the first output light.

FIG. 3 is a graph illustrating wavelength-power characteristic of the second output lights in FIG. 1.

FIG. 4 illustrates an example of the wavelength division device in FIG. 1 according to at least one example embodiment.

FIG. 5 illustrates some portion of the arrayed waveguide grating of FIG. 4.

FIG. 6 illustrates another example of the wavelength division device according to at least one example embodiment.

FIG. 7 illustrates another example of the wavelength division device according to at least one example embodiment.

FIG. 8 illustrates another example of the wavelength division device according to at least one example embodiment.

FIGS. 9A through 9F illustrate structure of the first MMI coupler in FIG. 8.

FIG. 10 is a perspective view of the first MMI coupler and the input waveguide in FIG. 8.

FIG. 11 is a block diagram illustrating an optical biosensor system according to at least one example embodiment.

FIG. 12 is a block diagram illustrating an optical biosensor system according to at least one example embodiment.

FIG. 13 illustrates an example of the optical biosensor in FIG. 12.

FIG. 14 is a block diagram illustrating an example of the detection unit in FIG. 12 according to at least one example embodiment.

### DETAILED DESCRIPTION OF EXAMPLE EMBODIMENTS

Various exemplary embodiments will be described more fully hereinafter with reference to the accompanying drawings, in which some exemplary embodiments are shown. Inventive concepts may, however, be embodied in many different forms and should not be construed as limited to the exemplary embodiments set forth herein. Rather, these exemplary embodiments are provided so that this disclosure will be thorough and complete, and will fully convey the scope of inventive concepts to those skilled in the art. In the drawings, the sizes and relative sizes of layers and regions may be exaggerated for clarity. Like numerals refer to like elements throughout.

It will be understood that, although the terms first, second, third etc. may be used herein to describe various elements, these elements should not be limited by these terms. These terms are used to distinguish one element from another. Thus, a first element discussed below could be termed a second element without departing from the teachings of inventive concepts. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular exemplary embodiments only and is not intended to be limiting of inventive concepts. As used herein, the singular forms “a,” “an” and “the” are intended to include the plural forms as well, unless the context clearly indicates otherwise. It will be further understood that the terms “includes”, “including”, “comprises”, and/or “comprising,” when used in this specification, specify the presence of stated features, integers, steps, operations, elements, and/or components, but do not preclude the presence or addition of one or more other features, integers, steps, operations, elements, components, and/or groups thereof.

Spatially relative terms, such as “below”, “beneath”, “lower”, “above”, “upper”, and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which inventive concepts belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

FIG. 1 is a block diagram illustrating a multi-wavelength light generator according to at least one example embodiment.

Referring to FIG. 1, a multi-wavelength light generator 10 includes a direct-modulation driver 110, a broadband light source 120 and a wavelength division device 200.

The direct-modulation driver 110 drives the broadband light source 120 by a direct modulation. That is, the direct-modulation driver 110 drives the broadband light source 120 by directly modulating pulse voltages applied to the broadband light source 120. The broadband light source 120 may be implemented with an amplified spontaneous emission (ASE) light-emitting diode (LED). The broadband light source 120 may generate a first output light P0 having a line width about 20-100 nm. The line width means a full width at half maximum (FWHM) of the first output light P0. The wavelength division device 200 divides a wavelength of the first output light P0 having a first line width to provide a plurality of second output lights P1-P4, each of the second output lights P1-P4 having a second line width narrower than the first line width. Each of the second output lights P1-P4 may be used as a light source in each channel where each of the second output lights P1-P4 is provided.

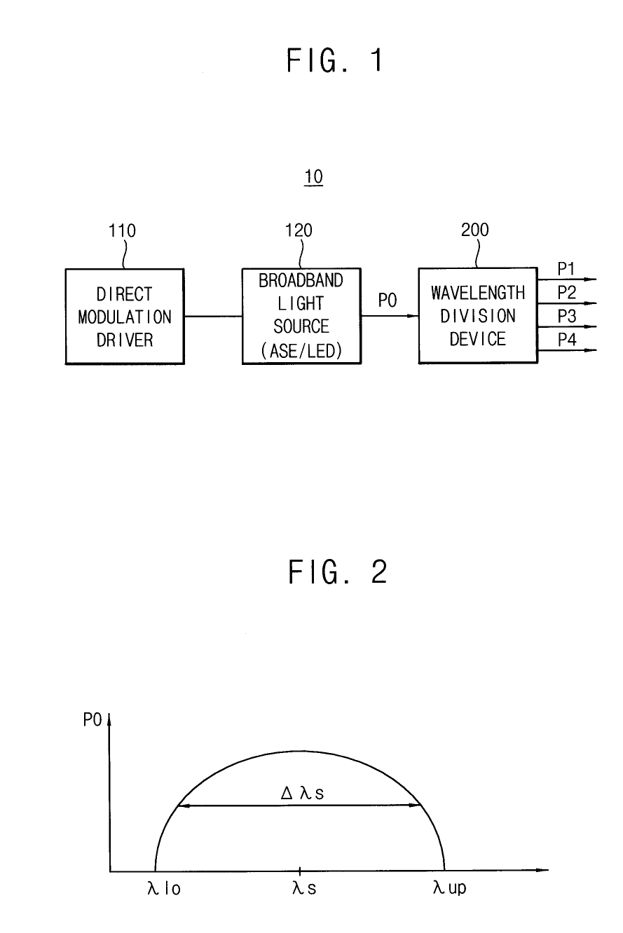

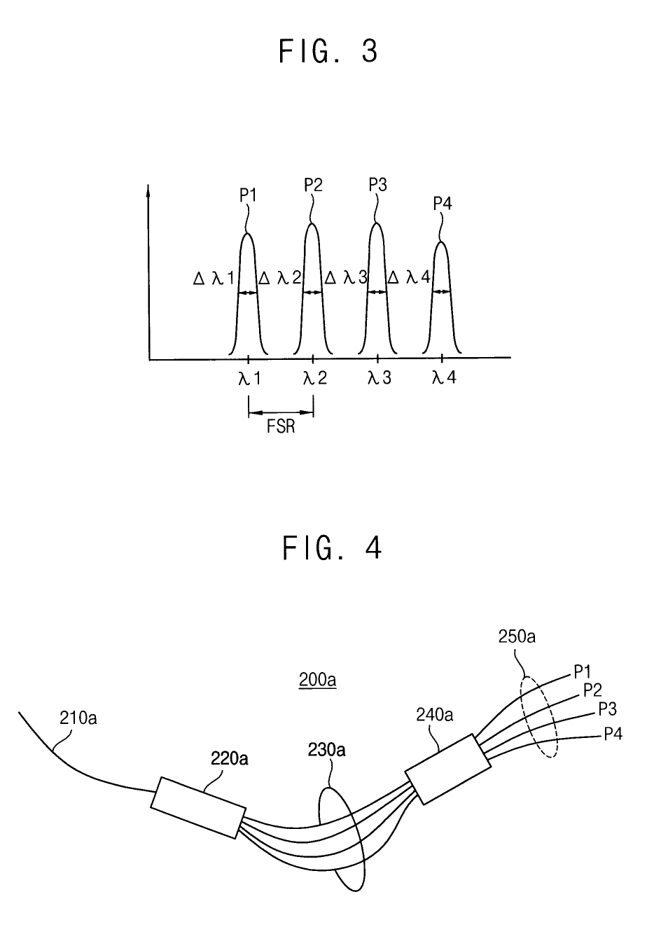

FIG. 2 is a graph illustrating wavelength-power characteristics of the first output light in FIG. 1, and FIG. 3 is a graph illustrating wavelength-power characteristics of the second output lights in FIG. 1.

Referring to FIG. 2, the first output light P0 may have a center wavelength λs between a lower-limit wavelength λlo and an upper-limit wavelength λup. In addition, the first output light P0 may have a first line width Δλs. In addition, the second output lights P1-P4 may have corresponding center wavelengths λ1, λ2, λ3 and λ4 and line widths Δλ1, Δλ2, Δλ3 and Δλ4. A difference between the center wavelengths λ1, λ2, λ3 and λ4 may correspond to a free spectrum range (FSR) of the wavelength division device 200.

FIG. 4 illustrates an example of the wavelength division device in FIG. 1 according to at least one example embodiment.

Referring to FIG. 4, a wavelength division device 200a includes an arrayed waveguide grating (AWG).

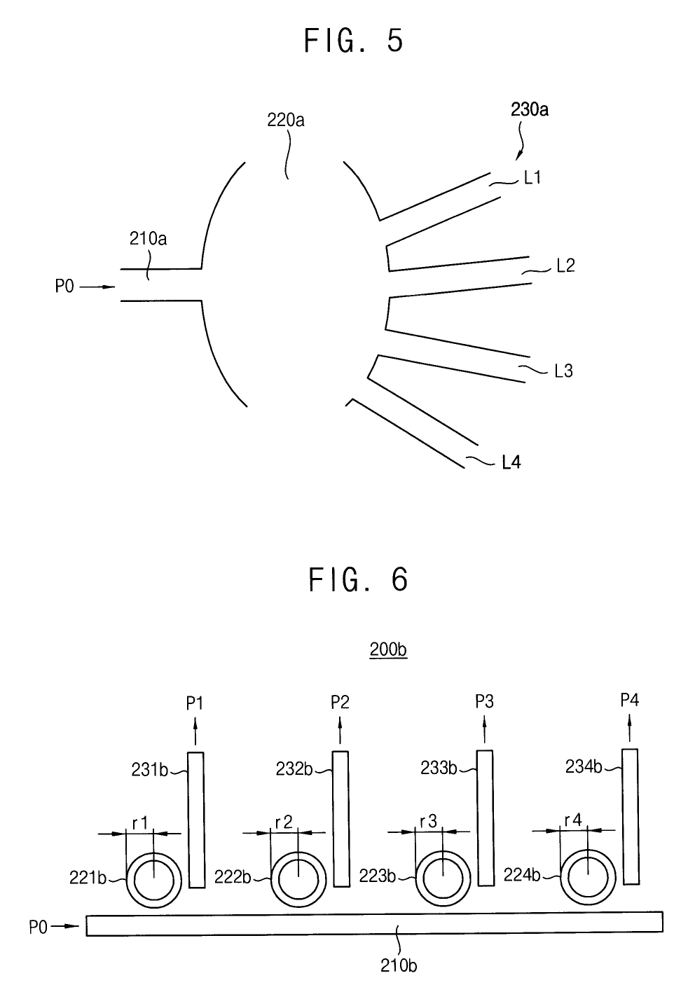

FIG. 5 illustrates a portion of the arrayed waveguide grating of FIG. 4.

Referring to FIGS. 4 and 5, an AWG includes an input waveguide 210, a first slab waveguide 220a, a waveguide array 230a, a second slab waveguide 240a and a plurality of output waveguides 250a. The input waveguide 210 receives the first output light P0, and the output waveguides 250a provides the second output lights P1-P4. The first slab waveguide 220a is connected to the input waveguide 210a, and the second slab waveguide 240a is connected to the output waveguides 250a. In addition, the waveguide array 230a connects the first slab waveguide 220a with the second slab waveguide 240a. When the first output light P0 is input from the input waveguide 220a to the first slab waveguide 220a, the first slab waveguide 220a spreads the first output light P0 with a certain distribution. The light passing through the first slab waveguide 220a is input to the waveguide array 230a including a plurality of waveguides L1-L4 having regular light path difference as illustrated in FIG. 5. The first output light P0 passing through the first slab waveguide 220a is divided into a plurality of optical signals in the waveguide array 230a, and the optical signals have different powers and regular phase differences. When the second slab waveguide 240a receives the optical signals having different powers and regular phase differences, the second slab waveguide 240a interferes the optical signals from the waveguides L1-L4. In addition, wavelengths of the optical signals from the waveguides L1-L4 are focused on certain positions of the second slab waveguide 240a. The output waveguides 250a outputs optical signals focused on certain positions of the second slab waveguide 240a as the second output lights.

A wavelength focused on the central axis of the second slab waveguide 240a may satisfy Equation 1 below.

$$β \cdot Δ L = \frac{2 π}{{λ}_{o}} \cdot {n}_{eff} \cdot Δ L = \pm 2 m π \qquad [ Equation 1 ]$$

In Equation 1, β denotes a propagation constant, n_{eff} denotes a mode refractive index of the input waveguide 210a, λ₀ denotes a center wavelength, m denotes a grating order of the waveguide array 230a, and ΔL denotes a path difference of the waveguide array 230a.

Here, a specific wavelength λ which has deviated from the center wavelength λ₀ by λp (λ=λ₀+λp) crosses the central axis at a specific angle, and may satisfy Equation 2 below.

$$\frac{2 π}{λ} \cdot {n}_{eff} \cdot Δ L = \frac{2 π}{λ} \cdot {n}_{slab} \cdot a \cdot θ \pm 2 m π \qquad [ Equation 2 ]$$

In Equation 2, λ denotes the specific wavelength which has deviated from the center wavelength λ₀ by λp, n_{slab} denotes a mode refractive index of a slab waveguide, ‘a’ denotes an interval between centers of the waveguide array 230a, and θ denotes an angle with respect to the central axis.

Therefore, by simultaneously solving Equation 1 and Equation 2, the angle θ of the specific wavelength λ with respect to the central axis may be expressed as shown in Equation 3 below.

$$\frac{2 π}{λ} \cdot {n}_{slab} \cdot a \cdot θ = 2 π \cdot Δ L ( \frac{{n}_{eff}^{λ}}{λ} - \frac{{n}_{eff}^{{λ}_{o}}}{{λ}_{o}} ) \\ θ = \frac{Δ L}{a} ( \frac{{n}_{eff}^{λ}}{{n}_{slab}^{λ}} - \frac{{n}_{eff}^{{λ}_{o}}}{{n}_{slab}^{{λ}_{o}}} \cdot \frac{λ}{{λ}_{o}} ) \qquad [ Equation 3 ]$$

In Equation 3, λ₀ denotes the center wavelength, λ denotes the specific wavelength which has deviated from the center wavelength λ₀ by λp, n_{eff} denotes the mode refractive index of the input waveguide 210a, n_{slab} denotes the mode refractive index of the slab waveguide, ‘a’ denotes an interval between centers of the waveguide array 230a, θ denotes the angle with respect to the central axis, and ΔL denotes the path difference of the waveguide array 230a.

Meanwhile, the power of light output to the output waveguides 250a while crossing the central axis at the angle θ may be expressed as shown in Equation 4 below.

$${E}_{θ} = {\sum }_{j = 1}^{n} {f}_{j} \cdot {g}_{j} \cdot exp ( 2 π i \cdot \frac{{n}_{eff}^{λ}}{λ} \cdot jΔ L ) \qquad [ Equation 4 ]$$

In Equation 4, fⱼ denotes an optical coupling coefficient of an optical signal transferred from the input waveguide 210a to the waveguide array 230a, gⱼ denotes an optical coupling coefficient of an optical signal transferred from the waveguide array 230a to the output waveguides 250a, the exponential function denotes a change in phase caused by a path difference between respective arrayed waveguides, and ‘n’ denotes a total number of waveguides of the waveguide array 230a.

In the case of the optical coupling coefficient fⱼ, all inputs are transferred along the central axis of the input waveguide 210a and thus have the same phase. On the other hand, in the case of the optical coupling coefficient gⱼ, inputs cross the central axis at the angle θ. Thus, in consideration of a change in phase according to the angle θ with respect to the central axis, the optical coupling coefficient gⱼ may be expressed as shown in Equation 5 below.

$${g}_{j} = {f}_{j} \cdot exp ( 2 π i \cdot \frac{{n}_{slab}^{λ}}{λ} \cdot j a θ ) \qquad [ Equation 5 ]$$

By inserting the optical coupling coefficient gⱼ obtained through Equation 5 into Equation 4, the power of an output optical signal may be expressed as shown in Equation 6 below.

$${E}_{θ} = {\sum }_{j = 1}^{n} {f}_{j}^{2} \cdot exp \{ 2 π i \cdot j ( \frac{{n}_{eff}^{λ}}{λ} \cdot Δ L + \frac{{n}_{slab}^{λ}}{λ} \cdot a θ ) \} \qquad [ Equation 6 ]$$

Therefore, it is noted that the center wavelengths λ1, λ2, λ3 and λ4 of the second output lights P1-P4 in FIG. 3 are determined by the path difference ΔL of the waveguides L1-L4 in the waveguide array 230a.

FIG. 6 illustrates another example of the wavelength division device according to at least one example embodiment.

Referring to FIG. 6, the wavelength division device 200 may include a ring-type demultiplexer 200b.

The ring-type demultiplexer 200b may include an input waveguide 210b, a plurality of ring resonators 221b-224b and a plurality of output waveguides 231b-234b. The ring resonators 221b-224b are disposed around the input waveguide 210b.

The output waveguides 231b-234b may be disposed adjacent to a side of each of the ring resonators 221b-224b. The output waveguides 231b-234b transmit light within a corresponding ring resonator externally.

The input waveguide 210b is formed of a material having a refractive index substantially different from that of a material therearound. For example, the input waveguide 210b may be silicon surrounded by silicon dioxide. Thus, the input waveguide 210b provides an optical path that can transmit light while minimizing energy losses of the first output light P0. Although the ring resonators 221b-224b are spaced from the input waveguide 210b, light having a desired (or alternatively, predetermined) wavelength is incident from the input waveguide 210b into the ring resonator having a corresponding resonant wavelength by an optical coupling phenomenon. The ring resonators 221b-224b have different radii (r1<r2<r3<r4) from each other. Since the ring resonators 221b-224b have different radii (r1<r2<r3<r4) from each other, the lights extracted from the ring resonators 221b-224b have different wavelengths. A wavelength spacing of lights extracted from corresponding ring resonators is may be determined by radius difference of corresponding ring resonators.

Each of the output waveguides 231b-234b is disposed adjacent to a side of each of the ring resonators 221b-224b. A process in which light is transmitted from the ring resonators 221b-224b to the corresponding output waveguides 231b-234b is enabled by the optical coupling phenomenon. Similar to the input waveguide 210b, the output waveguides 231b-234b are formed of a material having a refractive index substantially different from that of a material therearound. For example, the output waveguides 231b-234b may be silicon surrounded by silicon dioxide. The output waveguides 231b-234b disposed around the ring resonators 221b-224b output the second output lights P1-P4 having wavelengths different from one another. The wavelengths of the second output lights P1-P4 are mainly determined by physical structures of the ring resonators 221b-224b. When the ring resonators 221b-224b are formed of same materials, the wavelengths of the second output lights P1-P4 may be determined by each radius r1-r4 of the ring resonators 221b-224b.

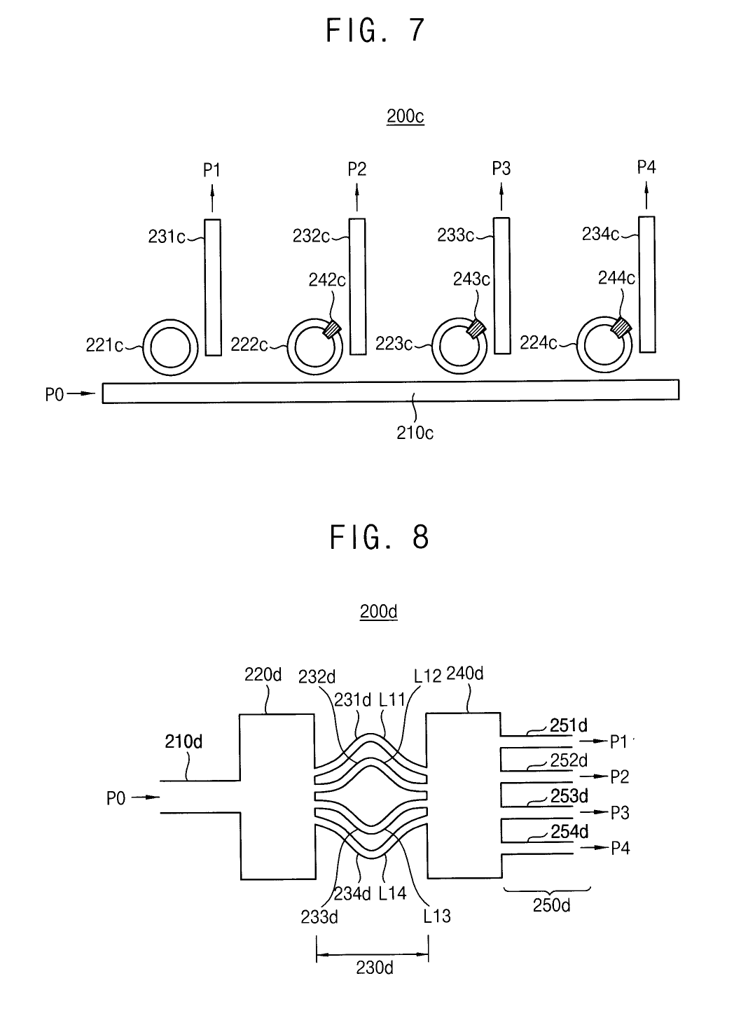

FIG. 7 illustrates another example of the wavelength division device according to at least one example embodiment.

Referring to FIG. 7, the wavelength division device 200 may include a ring-type demultiplexer 200c.

The ring-type demultiplexer 200c may include an input waveguide 210c, a plurality of ring resonators 221c-224c and a plurality of output waveguides 231c-234c. At least one tuning clad pattern (e.g., three tuning clad patterns 242c-244c) is disposed circumferentially around at least one of the ring resonators 221c-224c. The tuning clad patterns 242c-244c may be in contact with the ring resonators 222c-224c, respectively, and their contact areas may be different from one another. Since differences of the contact areas between the tuning clad patterns 242c-244c and the ring resonators 222c-224c. Wavelengths of the lights extracted from the ring resonators 221c-224c may be determined by differences of the contact areas between the tuning clad patterns 242c-244c and the ring resonators 222c-224c. The output waveguides 231c-234c is disposed adjacent to a side of each of the ring resonators 221c-224c.

Similar to the ring resonator shown with reference numeral 221c, the tuning clad patterns is not disposed around at least one of the ring resonators. When the ring resonators 221c-224c are formed of same material and have a same shape, the wavelengths of the second output lights P1-P4 may be different due to the tuning clad patterns 242c-244c having different contact areas. Therefore, a wavelength of corresponding second output light may be controlled by adjusting a contact area of the tuning clad pattern and a corresponding ring resonator.

FIG. 8 illustrates another example of the wavelength division device according to at least one example embodiment.

Referring to FIG. 8, the wavelength division device 200 may include a multi-mode interference (MMI)-based demultiplexer 200d.

The MMI-based demultiplexer 200d may include an input waveguide 210d that receives the first output light P0, a first MMI coupler 220d, a waveguide array 230d, a second MMI coupler 240d and a plurality of output waveguides 251d-254d.

In FIG. 8, the first MMI coupler 220d is connected to the input waveguide 210d. The second MMI coupler 240d is connected to the output waveguides 251d-254d. The waveguide array 230d connects the first MMI coupler 220d with the second MMI coupler 240d. The first MMI coupler 220d radiates the first output light P0 passing through the input waveguide 210d. The radiated light may be coupled to the waveguide array 230d. Waveguides 231d-234d in the waveguide array 230d have different optical paths L11-L14. The first output light P0 passing through the MMI coupler 220d is divided into a plurality of optical signals in the waveguide array 230d, and the optical signals have different powers and regular phase differences. When the second MMI coupler 240d receives the optical signals having different powers and regular phase differences, the second MMI coupler 240d interferes the optical signals from the waveguides 231d-234d. In addition, wavelengths of the optical signals from the waveguides 231d-234d are focused on certain positions of the second MMI coupler 240d. The output waveguides 250d output optical signals focused on certain positions of the second MMI coupler 240d as the second output lights P1-P4.

The center wavelengths of the second output lights P1-P4 are determined by the path difference of the waveguides 231d-234d in the waveguide array 230d.

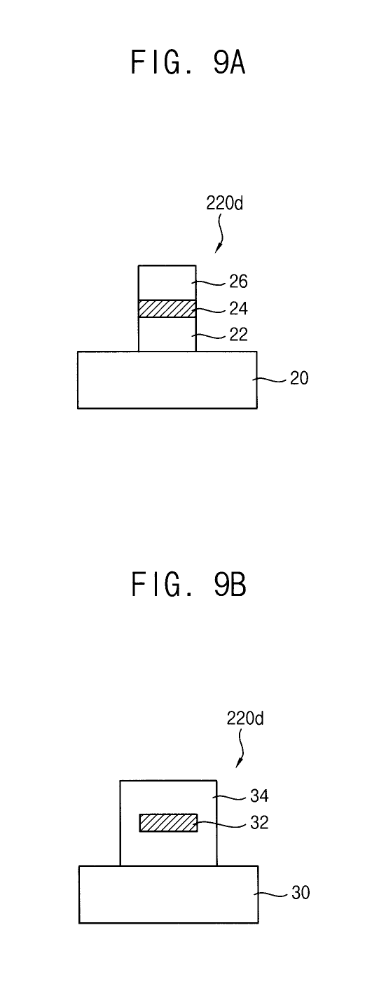

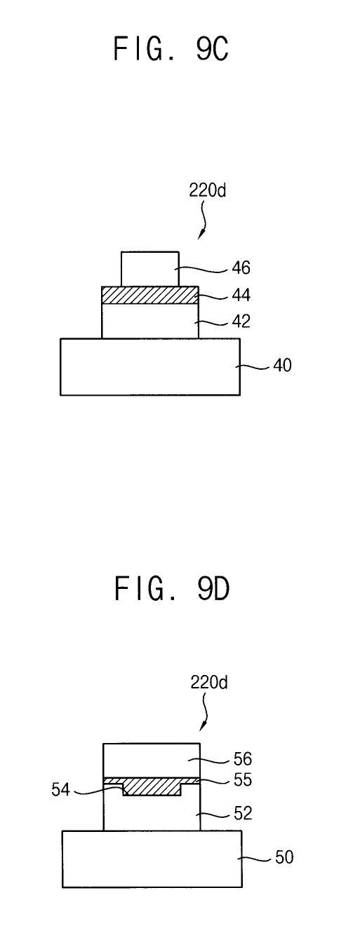

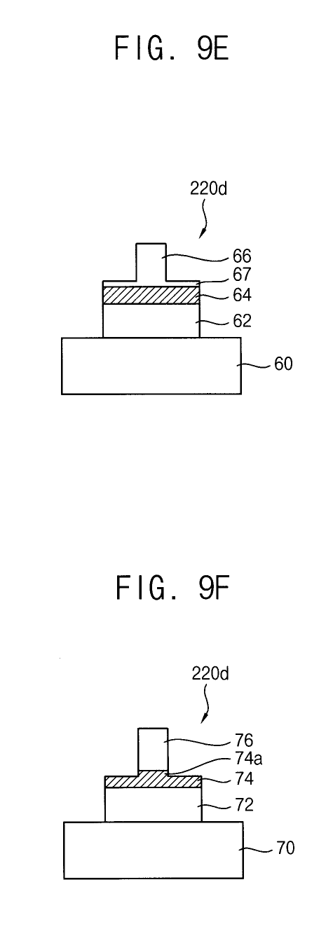

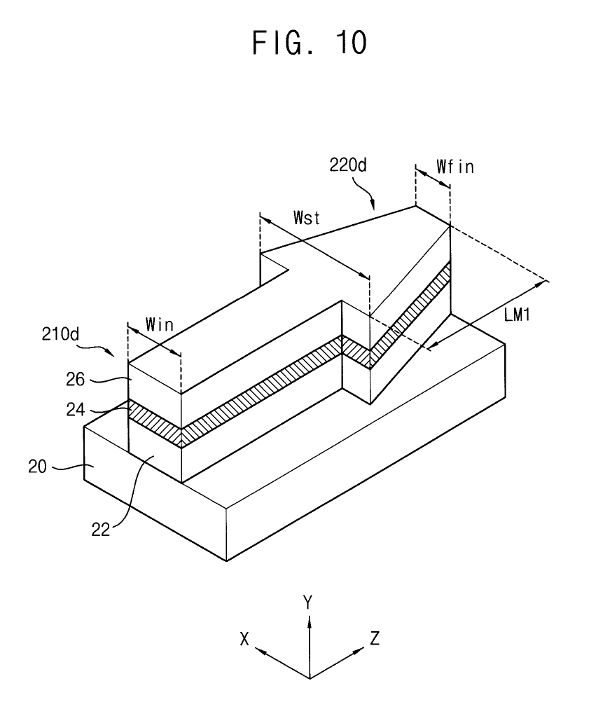

FIGS. 9A through 9F illustrate example structures of the first MMI coupler in FIG. 8.

Referring to FIG. 9A, the first MMI coupler 220d may have a deep ridge waveguide (e.g., deep RWG) structure. The first MMI coupler 220d may be integrated with the input waveguide 210d. The first MMI coupler 220d and the input waveguide 210d may include a lower clad layer 22, a core, 24, and an upper clad layer 26, which are sequentially stacked on a substrate 20. Lateral surfaces of the lower clad layer 22, the core 24, and the upper clad layer 26 may be aligned with each other.

The substrate 20 may be formed of silica, silicon, amorphous silicon, InP, GaAs, LiTaO₃, or polymer. When the substrate 20 is formed of InP, the core 24 may be formed of InGaAsP.

Referring to FIG. 9B, the first MMI coupler 220d may have a buried hetero structure (BH). The first MMI coupler 220d may be integrated with the input waveguide 210d. The first MMI coupler 220d and the input waveguide 210d may include a substrate 30, a core 32, and a clad layer 34. The core 32 and the clad layer 34 may be disposed on the substrate 30. The clad layer 34 may surround the core 32.

Referring to FIG. 9C, the first MMI coupler 220d may have a shallow RWG structure. The first MMI coupler 220d and the input waveguide 210d may include a lower clad layer 42, a core 44, and an upper clad layer 46, which are sequentially stacked on a substrate 40. Lateral surfaces of the core 42 and the lower clad layer 44 may be aligned with each other. The upper clad layer 46 may be disposed on the core 44. The upper clad layer may have a width less than that of the core 44.

Referring to FIG. 9D, the first MMI coupler 220d may have a rib WG structure. The first MMI coupler 220d and the input waveguide 210d may include a lower clad layer 52, a core 55, and an upper clad layer 56, which are sequentially stacked on a substrate 50. Lateral surfaces of the core 55, the lower clad layer 52, and the upper clad layer 56 may be aligned with each other. The upper clad layer 56 may be disposed on the core 55. The lower clad layer 52 may include a trench defined in a central region thereof. The core 55 may fill the trench 54 and be disposed on the lower clad layer 52.

Referring to FIG. 9E, the first MMI coupler 220d and the input waveguide 210d may include a lower clad layer 62, a core 64, and an upper clad layer 67, which are sequentially stacked on a substrate 60. Lateral surfaces of the lower clad layer 62, the core 64, and the upper clad layer 67 may be aligned with each other. The upper clad layer 67 may be disposed on the core 64. The upper clad layer 67 may include a protrusion 66 in a central region thereof.

Referring to FIG. 9F, the first MMI coupler 220d and the input waveguide 210d may include a lower clad layer 72, a core 74, and an upper clad layer 76, which are sequentially stacked a substrate 70. Lateral surfaces of the core 74 and the lower clad layer 72 may be aligned with each other. The core 74 may include a core protrusion 74a in a central region thereof. The upper clad layer 76 may be disposed on the core protrusion 74a. Lateral surfaces of the core protrusion 74a and the upper clad layer 76 may be aligned with each other.

FIG. 10 is a perspective view of the first MMI coupler and the input waveguide in FIG. 8.

Referring to FIG. 10, the first MMI coupler 220d and the input waveguide 210d may have a deep RWG structure. The first MMI coupler 220d and the input waveguide 210d may include a lower clad layer 22, a core 24, and an upper clad layer 26, which are sequentially stacked on a substrate 20. Lateral surfaces of the lower clad layer 22, the core 24, and the upper clad layer 26 may be aligned with each other.

The substrate 20 may include an InP substrate. The core 24 may be formed of InGaAsP having a certain band gap.

The first MMI coupler 220d has an input width Wst greater than an output width Wfin thereof. When a width of the first MMI coupler 220d is tapered, a width of an interference pattern within the first MMI coupler 220d gradually becomes narrower, and a period of the interference pattern gradually becomes shorter during beam propagation. The interference pattern may have various widths according to a length LM1 of the first MMI coupler 220d.

The second MMI coupler 240d may have a substantially same structure of the first MMI coupler 220d.

As mentioned above, in the multi-wavelength light generator 10, one direct modulation driver 110 drives the one broadband light source 120 to output the first output light P0 having a first line width, and the wavelength division device 200 divides the wavelength of the first output light P0 to generate the second output lights P1-P4, each having a second line width narrower than the first line width. Difference between the center wavelengths of the second output lights P1-P4 may correspond to a free spectrum range (FSR) of the wavelength division device 200. Therefore, the multi-wavelength light generator 10 may be manufactured in small size and with a low cost.

FIG. 11 is a block diagram illustrating an optical biosensor system according to at least one example embodiment.

Referring to FIG. 11, an optical biosensor system 300 includes a multi-wavelength light generator 310, a biosensor 320 and a detection unit 330.

The multi-wavelength light generator 310 includes a direct modulation driver 313, a broadband light source 311 and a wavelength division device 312. As described with reference to FIG. 1, the broadband light source 311 may generate a first output light P0 having a line width about 20-100 nm. The line width means a full width at half maximum (FWHM) of the first output light P0. The wavelength division device 312 divides a wavelength of the first output light P0 having a first line width to provide a plurality of second output lights P1-P4, each having a second line width narrower than the first line width. The broadband light source 311 may be implemented with an amplified spontaneous emission (ASE) light-emitting diode (LED).

In at least one example embodiment, the multi-wavelength light generator 310 may further include an optical detector that detects output power of the first output light P0. The optical detector may be implemented with at least one of a photo-diode, an optical multiplier, a charge-coupled device (CCD) and a CMOS image sensor (CIS). The optical detector may control the multi-wavelength light generator 310 such that the first output light P0 has a desired output power.

The second output lights P1-P4, each having a second line width, are provided to the biosensor 320. The optical biosensor 320 may fix an antibody. The optical biosensor 320 may receive an antigen from blood, etc. The optical biosensor 320 may shift at least one peak wavelength of the second output lights P1-P4 according to antibody-antigen reaction. For example, the optical biosensor 320 may shift at least one peak wavelength of the second output lights P1-P4 to provide reacted lights Pr1-Pr4 to the detection unit 330. The detection unit 330 detects peak wavelengths of the reacted lights Pr1-Pr4 to display a presence and concentration of an antigen. The detection unit may include a display unit that displays the presence and concentration of an antigen using the peak wavelength.

In at least one example embodiment, the optical bio sensor 320 may fix a plurality of antibodies. The optical biosensor 320 may shift peak wavelengths of the second output lights P1-P4 according to antibody-antigen reaction of the received antigen. The detection unit 330 detects peak wavelengths of the reacted lights Pr1-Pr4 to display a presence and concentration of corresponding antigens.

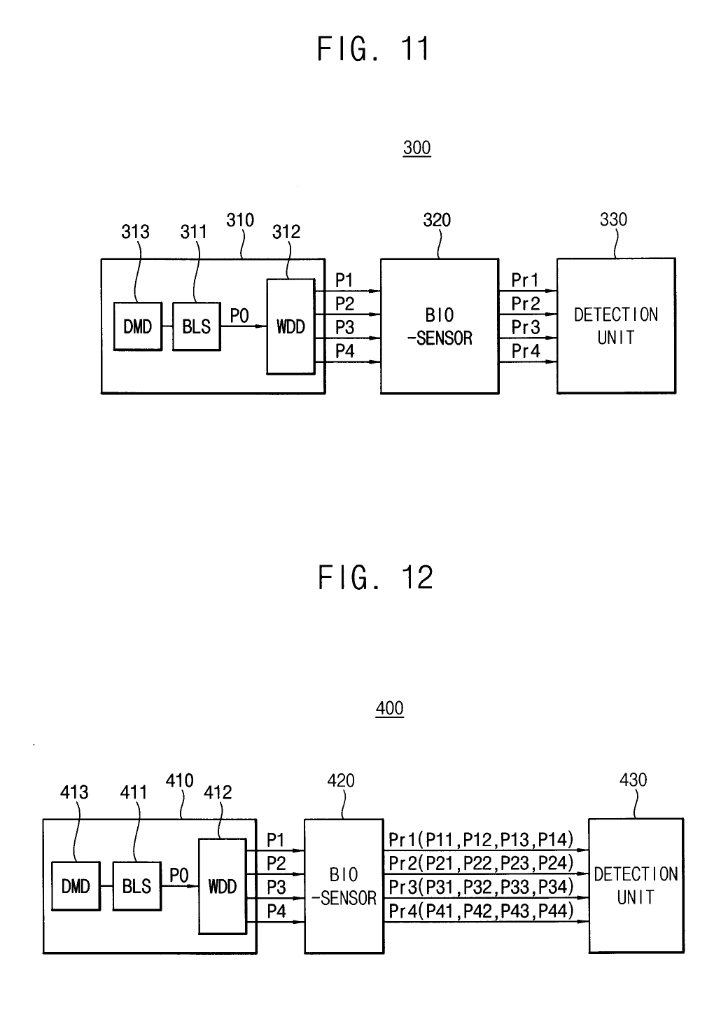

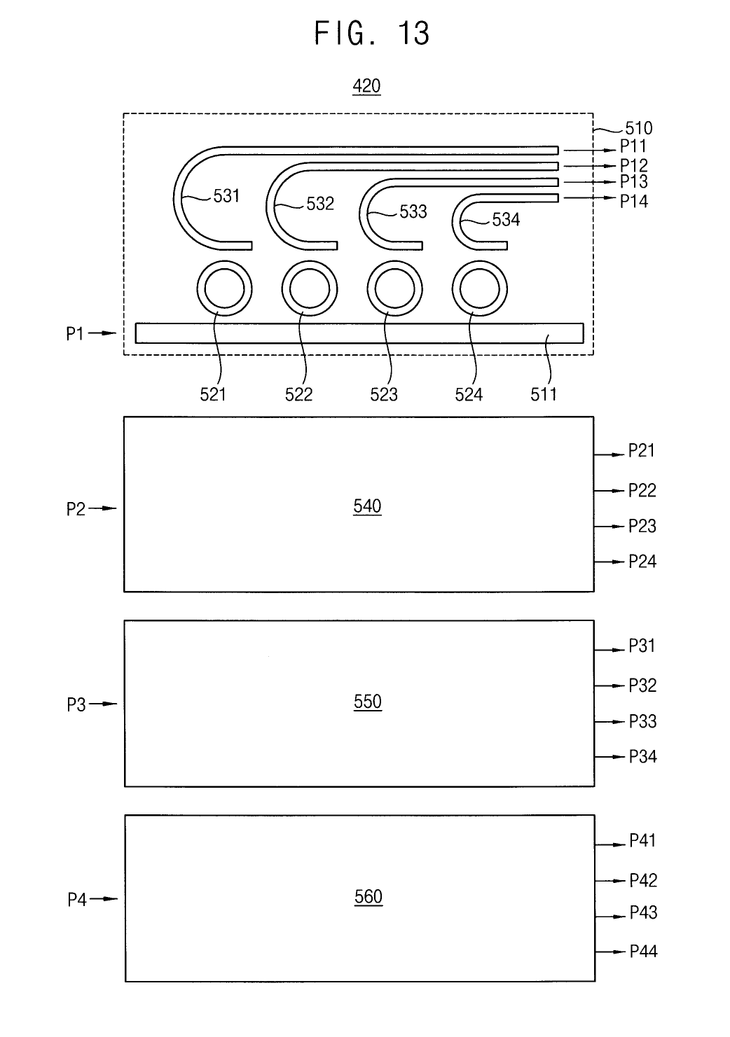

FIG. 12 is a block diagram illustrating an optical biosensor system according to at least one example embodiment.

Referring to FIG. 12, an optical biosensor system 400 includes a multi-wavelength light generator 410, a bio sensor 420 and a detection unit 430.

The multi-wavelength light generator 410 includes a direct modulation driver 413, a broadband light source 411 and a wavelength division device 412. As described with reference to FIG. 1, the broadband light source 411 may generate a first output light P0 having a line width about 20-100 nm. The line width means a full width at half maximum (FWHM) of the first output light P0. The wavelength division device 412 divides a wavelength of the first output light P0 having a first line width to provide a plurality of second output lights P1-P4, each having a second line width narrower than the first line width. The broadband light source 411 may be implemented with an amplified spontaneous emission (ASE) light-emitting diode (LED).

In at least one example embodiment, the multi-wavelength light generator 410 may further include an optical detector that detects output power of the first output light P0. The optical detector may be implemented with at least one of a photo-diode, an optical multiplier, a charge-coupled device (CCD) and a CMOS image sensor (CIS). The optical detector may control the multi-wavelength light generator 310 such that the first output light P0 has a desired output power.

The second output lights P1-P4, each having a second line width, are provided to the biosensor 420. The optical biosensor 420 may fix a plurality of antibodies. The optical biosensor 420 may receive an antigen from blood, etc. The optical biosensor 420 may shift peak wavelengths of the second output lights P1-P4 according to antibody-antigen reaction. The optical biosensor 420 may shift the peak wavelengths of the second output lights P1-P4 to provide reacted lights Pr1-Pr4 to the detection unit 430. The detection unit 430 detects peak wavelengths of the reacted lights Pr1-Pr4 to display presence and concentration of the antigen responding to corresponding antibody. The reacted light Pr1 may include reacted lights P11, P12, P13 and P14 which are based on reaction of each of the antibodies and first antigen. The reacted light Pr2 may include reacted lights P21, P22, P23 and P24 which are based on reaction of each of the antibodies and second antigen. The reacted light Pr3 may include reacted lights P31, P32, P33 and P34 which are based on reaction of each of the antibodies and third antigen. The reacted light Pr4 may include reacted lights P41, P42, P43 and P44 are respectively based on reaction of each of the antibodies and fourth antigen. The detection unit may include a microprocessor that detects the presence and concentration of an antigen, and a display unit that displays the presence and concentration of an antigen using the peak wavelength.

FIG. 13 illustrates an example of the optical biosensor in FIG. 12.

Referring to FIG. 13, the optical biosensor 420 includes a plurality of ring arrays 510, 520, 530 and 540 having same configurations. Each of the ring arrays 510, 520, 530 and 540 may fix a plurality of antibodies and shift the peak wavelengths of the second output lights P1-P4 to provide reacted lights P11-P14, P21-P24, P31-P34 and P41-P44 to the detection unit 430.

The ring array 510 includes an input waveguide 511 that receives the second output light P1, a plurality of ring resonators 521, 522, 523 and 524 disposed between the input waveguide 511 and a plurality of output waveguides 531, 532, 533 and 534 that output reacted lights P11, P12, P13 and P14 whose peak wavelengths are shifted. The ring resonators 521, 522, 523 and 524 may have radii different from each other.

Each of the ring arrays 540, 550 and 560 may have a substantially same configuration of the ring array 510.

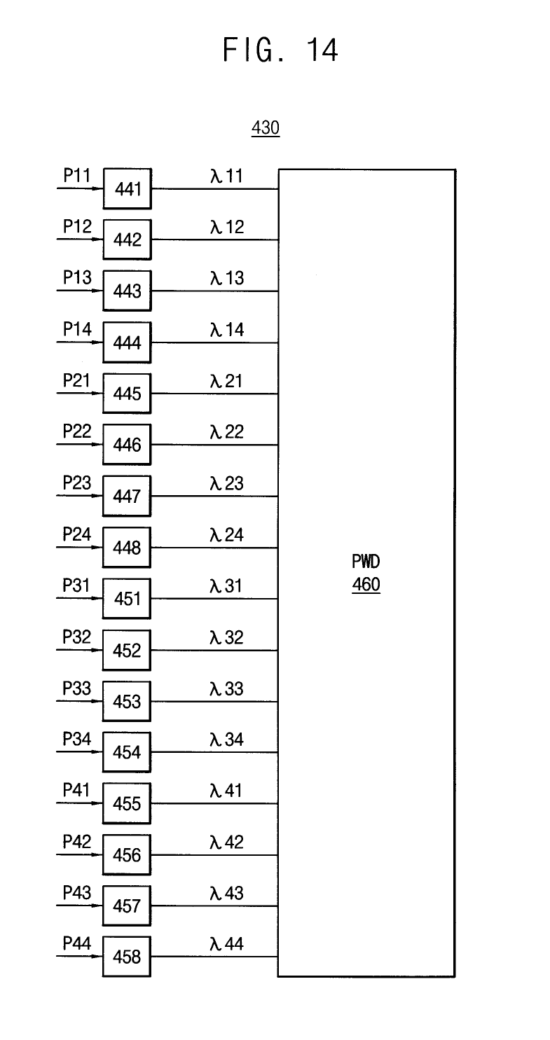

FIG. 14 is a block diagram illustrating an example of the detection unit in FIG. 12 according to at least one example embodiment.

Referring to FIG. 14, the detection unit 430 includes a plurality of light-receiving units 441-448 and 451-458 and a peak wavelength detector 460.

Each of the light-receiving units 441-448 and 451-458 may be implemented with at least one of a photo-diode, an optical multiplier, a charge-coupled device (CCD) and a CMOS image sensor (CIS). Each of the light-receiving units 441-448 and 451-458 receives each of the reacted lights P11-P14, P21-P24, P31-P34 and P41-P44. The peak wavelength detector 460 may detect each peak wavelength of the reacted lights P11-P14, P21-P24, P31-P34 and P41-P44 by measuring each current from the light-receiving units 441-448 and 451-458. When the light-receiving units 441-448 and 451-458 are implemented with a photo-diode, each current from the light-receiving units 441-448 and 451-458 may be varied according to a reverse bias voltage applied to the light-receiving units 441-448 and 451-458. Each current from the light-receiving units 441-448 and 451-458 is dependent on wavelength. Therefore, the peak wavelength detector 460 may detect each peak wavelength of the reacted lights P11-P14, P21-P24, P31-P34 and P41-P44 by measuring each current from the light-receiving units 441-448 and 451-458 in response to the reverse bias voltage.

As mentioned above, the multi-wavelength light generator and the biosensor system may reduce power consumption and overall system size because each channel receives a light source generated by dividing a wavelength of one broadband light source.

Example embodiments may be applicable to various sensor systems employing a multi-wavelength light generator.

Inventive concepts may be applied to various test apparatus for measuring EMI. The foregoing is illustrative of exemplary embodiments and is not to be construed as limiting thereof. Although a few exemplary embodiments have been described, those skilled in the art will readily appreciate that many modifications are possible in the exemplary embodiments without materially departing from the novel teachings and advantages of inventive concepts. Accordingly, all such modifications are intended to be included within the scope of inventive concepts as defined in the claims.

What is claimed is:

1. A multi-wavelength light generator, comprising:
a broadband light source configured to generate a first output light having a first line width; and
a wavelength division device configured to divide a wavelength of the first output light to provide a plurality of second output lights, each of the second output lights having a second line width narrower than the first line width, and each of the second output lights being a light source of each channel in an optical sensor.

2. The multi-wavelength light generator of claim 1, further comprising:
a driver configured to drive the broadband light source by direct modulation.

3. The multi-wavelength light generator of claim 1, wherein the broadband light source includes an amplified spontaneous emission (ASE) light-emitting diode (LED).

4. The multi-wavelength light generator of claim 1, wherein the wavelength division device includes an arrayed waveguide grating (AWG).

5. The multi-wavelength light generator of claim 4, wherein the AWG comprises:
an input waveguide configured to receive the first output light;
a plurality of output waveguides configured to output the plurality of second output lights;
a first slab waveguide connected to the input waveguide;
a second slab waveguide connected to the plurality of output waveguides; and
a waveguide array connected to the first slab waveguide and the second slab waveguide.

6. The multi-wavelength light generator of claim 1, wherein the wavelength division device includes a ring-type demultiplexer.

7. The multi-wavelength light generator of claim 6, wherein the ring-type demultiplexer comprises:
an input waveguide configured to receive the first output light;
a plurality of ring resonators adjacent to the input waveguide; and
a plurality of output waveguides adjacent to the plurality of ring resonators, each of the output waveguides being configured to provide each of the second output lights.

8. The multi-wavelength light generator of claim 7, wherein a center wavelength of each of the second output lights is determined by each radius of the plurality of ring resonators.

9. The multi-wavelength light generator of claim 8, wherein each ring resonator in the plurality of ring resonators has a different radius.

10. The multi-wavelength light generator of claim 1, wherein the wavelength division device includes a multi-mode interference (MMI)-based demultiplexer.

11. The multi-wavelength light generator of claim 10, wherein the MMI-based demultiplexer comprises:
an input waveguide configured to receive the first output light;
a plurality of output waveguides configured to output the plurality of second output lights;
a first MMI coupler connected to the input waveguide;
a second MMI coupler connected to the plurality of output waveguides; and
a waveguide array connected to the first MMI coupler and the second MMI coupler.

12. The multi-wavelength light generator of claim 11, wherein a center wavelength of each of the second output lights is determined by a length of each waveguide in a plurality of waveguides in the waveguide array.

13. An optical biosensor system comprising:
a multi-wavelength light generator configured to generate a plurality of second output lights based on a first output light having a first line width, each of the second output lights having a second line width narrower than the first line width;
an optical biosensor configured to receive the plurality of second output lights; and
a detection unit configured to receive a plurality of reacted lights and detect each peak wavelength of the reacted lights, the reacted lights being based on antibody-antigen reaction of the plurality of second output lights,
the multi-wavelength light generator including
a broadband light source configured to generate the first output light, and
a wavelength division device configured to divide a wavelength of the first output light to provide the plurality of second output lights, each of the second output lights being a light source of each channel between the optical biosensor and the detection unit.

14. The optical biosensor system of claim 13, wherein the detection unit comprises:
a plurality of photodiodes configured to receive the plurality of reacted lights; and
a peak wavelength detector configured to detect a peak wavelength in each photodiode of the plurality of photodiodes.

15. The optical biosensor system of claim 14, wherein the peak wavelength detector is configured to detect the peak wavelength by measuring a current generated by a reverse bias voltage applied to each photo-diode of the plurality of photodiodes.

16. A wavelength division device, comprising:
a first coupler configured to divide input light having a first line width into a plurality of first output lights having a second line width, the second line width being less than the first line width;
a second coupler configured to output a plurality of second output lights based on the plurality of first output lights, each of the plurality of second output lights being a light source of each channel of an optical sensor; and
a waveguide configured to transmit the plurality of first output lights to the second coupler.

17. The wavelength division device of claim 16, wherein at least one of the first and second couplers comprises:
a substrate; and
an interference pattern on the substrate, the interference pattern including
a lower clad layer,
an upper clad layer, and
a core layer between the lower clad layer and the upper clad layer.

18. The wavelength division device of claim 17, wherein the lower clad layer includes a trench, and the core layer fills the trench.

19. The wavelength division device of claim 17, wherein the upper clad layer includes a clad protrusion portion extending from a center region of the upper clad layer.

20. The wavelength division device of claim 17, wherein a width of the interference pattern gradually decreases over a length of interference pattern.
